(19) United States
(12) Patent Application Publication
(10) Pub. No.: US 2023/0294596 A1
(43) Pub. Date: Sep. 21, 2023

(54) HAZARD FLASHER AND WARNING UNIT FOR VEHICLES

(71) Applicant: BAAL PATENT AB, Lomma (SE)

(72) Inventor: Johan WENNERHOLM, Lomma (SE)

(21) Appl. No.: 18/020,446

(22) PCT Filed: Jun. 22, 2021
(86) PCT No.: PCT/SE2021/050614

§ 371 Date: Feb. 9, 2023

(30) Foreign Application Priority Data
Aug. 19, 2020 (SE) 2050964-2

(51) Int. Cl. B60Q 1/46; B60Q 1/26; B60Q 1/52; F21S 43/15

(52) U.S. Cl. CPC B60Q 1/46; B60Q 1/2661; B60Q 1/52; F21S 43/15; F21Y 2115/10

(57) ABSTRACT

The present invention describes a vehicle 10 comprising a hazard flasher and warning unit 1, wherein the hazard flasher and warning unit 1 5 comprises an on/off unit connected to a light unit 2 mounted on a rear wiper arm 3 arranged at the rear window of the vehicle 10.

### FIELD OF THE INVENTION

The present invention relates to a vehicle comprising a hazard flasher and warning unit and to a hazard flasher and warning unit intended for vehicles.

### TECHNICAL BACKGROUND

Today the hazard flasher is normally provided by the four flashers of a car. The present invention provides an improvement to existing hazard flasher units for vehicles, especially for cars.

### DESCRIPTION OF THE INVENTION AND SPECIFIC EMBODIMENTS

According to the present invention there is provided a vehicle comprising a hazard flasher and warning unit, wherein the hazard flasher and warning unit comprises an on/off unit connected to a light unit, and wherein at least a part of the light unit is mounted on a rear wiper arm of the vehicle. The rear wiper arm of the vehicle is in turn arranged onto the rear window of the vehicle.

In US2018170248 there is disclosed a vehicle warning device for signaling trailing motorists, which includes a housing that defines an internal space. The housing is configured to mount to a vehicle such that a front face of the housing is visible from a rear side of the vehicle. Moreover, a plurality of lights is coupled to the housing and is positioned on the front face. The lights are operationally couplable to a throttle, a brake system and an electrical circuit of the vehicle. Furthermore, the lights are configured to selectively illuminate to signal to trailing motorists a position of the throttle and a state of the brake system of the vehicle.

The present invention provides an improvement to existing solutions. First of all, by incorporating the light unit onto the rear window of the vehicle or onto a unit arranged at the rear window of the vehicle the visibility of a warning indication is improved for vehicles approaching from the back. Secondly, by using the rear window as the platform for integration of the light units, an already existing part of the vehicles, such as a car or a bus, is used. This implies that the integration of the present invention is simple to perform also on existing cars and buses etc.

Below several embodiments of the present invention are provides and described further.

According to one embodiment of the present invention, the light unit comprises several LED lights, preferably more than 5 LED lights, most preferably 8-10 LED lights. LED lights are of interest as these provides a high visibility and at the same time is simple to mount onto a rear window or unit thereon.

According to yet another embodiment of the present invention, preferably the light unit comprises several LED units mounted in a row on the rear wiper arm of the vehicle, more preferably comprising more than 5 LED lights, most preferably comprising 8-10 LED lights. To use the wiper arm as the basis for mounting the light units, preferably LED light units, has the advantages that it is a simple integration and provides clear visibility for a vehicle approaching another one, when the hazard warning system according to the present invention is activated. In this regard it should also be said that, according to one specific embodiment the rear wiper arm is arranged to be activated when the light units are activated by the on/off unit. This implies that the rear wiper arm also wipes when the warning light units are activated.

According to yet another embodiment, the on/off unit is a hazard flasher on/off unit. This implies that the regular hazard flasher on/off unit, e.g. in a car, is intended as the activator also for the light unit of the hazard flasher and warning unit according to the present invention.

According to yet another specific embodiment of the present invention, said light unit is arranged to provide flashing light when activated, preferably orange flashing light when activated. Also this embodiment is thought as a complement to the existing warning systems used today. It should be noted that also clear illumination without flashing is possible according to the present invention.

The present invention also provides a hazard flasher and warning unit intended for a vehicle, said hazard flasher and warning unit being complemented with an extra light unit mounted on the rear wiper arm of the vehicle, preferably wherein the light unit comprises several LED units mounted in a row on the rear wiper arm of the vehicle.

As mentioned above, according to one embodiment, the light unit comprises more than 5 LED lights, more preferably comprises 8-10 LED lights. Furthermore, suitably light units are arranged to provide flashing light when activated, preferably orange flashing light when activated. As mentioned above, flashing lights are one possibility according to the present invention, clear illumination is another one. Moreover, and as also said above, according to yet another specific embodiment of the present invention the rear wiper arm is arranged to be activated when the light units are activated by the on/off unit.

Furthermore, according to yet another specific embodiment, the hazard flasher and warning unit is arranged to be activated simultaneously as the flashers of the vehicle, such as the four flashers of a car or bus.

The activation of the hazard flasher and warning unit according to the present invention may be established by use of different techniques. As should be understood from above, this may be performed totally by use of the existing system in a car or bus and then the light unit is only added as one extra unit to be activated when activating the on/off unit. Other possible solutions involve wireless transmission. Moreover, standard LED units are possible to use, however the colour of the light used should be adapted for vehicles and standards used in vehicles.

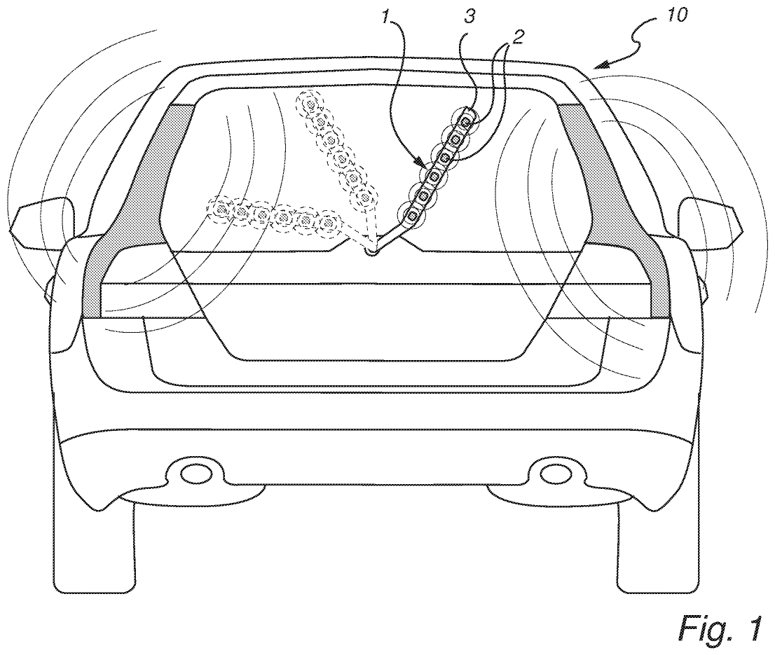

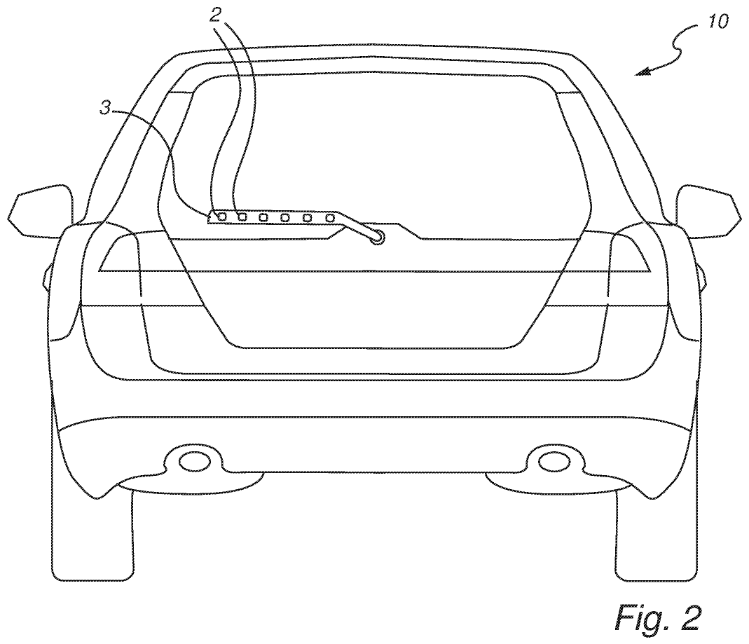

Below there are shown one embodiment according to the present invention. In this case, and as seen, LED lights are provided in a row on the rear wiper arm. The hazard on/off unit is activated implying that the system according to the present invention is activated. The activation ensures that rear blinker lights are flashing while the rear wiper arm has illuminated LED lights, flashing or not, at the same time. Moreover, as seen when comparing FIGS. 1 and 2, the rear wiper arm is wiping back and forth.

In FIGS. 1 and 2 there are shown one embodiment of the present invention. The vehicle 10 comprises a hazard flasher and warning unit 1, wherein the hazard flasher and warning unit 1 comprising an on/off unit connected to a light unit 2 which is mounted on a rear wiper arm 3 of the vehicle 10.

1. A vehicle comprising a hazard flasher and warning unit, wherein the hazard flasher and warning unit comprises an on/off unit connected to a light unit, and wherein at least a part of the light unit (2) is mounted on a rear wiper arm of the vehicle.

2. The vehicle according to claim 1, wherein the light unit comprises several LED lights, preferably more than 5 LED lights, most preferably 8-10 LED lights.

3. The vehicle according to claim 1, wherein the light unit comprises several LED units mounted in a row on the rear wiper arm of the vehicle, more preferably comprising more than 5 LED lights, most preferably comprising 8-10 LED lights.

4. The vehicle according to claim 3, wherein the rear wiper arm is arranged to be activated when the light units are activated by the on/off unit.

5. The vehicle according to claim 1, wherein the on/off unit is a hazard flasher on/off unit.

6. The vehicle according to claim 1, wherein said light unit is arranged to provide flashing light when activated, preferably orange flashing light when activated.

7. A hazard flasher and warning unit intended for a vehicle, said hazard flasher and warning unit being complemented with an extra light unit mounted on the rear wiper arm of the vehicle, preferably wherein the light unit comprises several LED units mounted in a row on the rear wiper arm of the vehicle.

8. The hazard flasher and warning unit according to claim 7, wherein the light unit comprises more than 5 LED lights, more preferably comprises 8-10 LED lights.

9. The hazard flasher and warning unit according to claim 7, wherein the rear wiper arm is arranged to be activated when the lights of light unit are activated by the on/off unit.

10. The hazard flasher and warning unit according to claim 7, wherein the light unit is arranged to provide flashing light when activated, preferably orange flashing light when activated.

11. The hazard flasher and warning unit according to claim 7, wherein the hazard flasher and warning unit is arranged to be activated simultaneously as the flashers of the vehicle.
